(19) United States
(12) Patent Application Publication
(10) Pub. No.: US 2024/0276329 A1
(43) Pub. Date: Aug. 15, 2024

(54) MOBILITY FOR A MOBILE INTEGRATED ACCESS AND BACKHAUL CELL

(71) Applicant: QUALCOMM Incorporated, San Diego, CA (US)

(72) Inventors: Navid ABEDINI, Basking Ridge, NJ (US); Naeem AKL, Bridgewater, NJ (US); Karl Georg HAMPEL, Jersey City, NJ (US); Junyi LI, Fairless Hills, PA (US)

(21) Appl. No.: 18/433,772

(22) Filed: Feb. 6, 2024

Related U.S. Application Data
(60) Provisional application No. 63/484,910, filed on Feb. 14, 2023.

(51) Int. Cl. H04W 36/08; H04W 36/32; H04W 84/04

(52) U.S. Cl. CPC H04W 36/08; H04W 36/324; H04W 84/047

(57) ABSTRACT

Various aspects of the present disclosure generally relate to wireless communication. In some aspects, a user equipment (UE) may receive an indication that a cell is associated with a mobile integrated access and backhaul (IAB) status. The UE may perform a cell selection or reselection operation based at least in part on an onboard status between the UE and the cell and based at least in part on the cell being associated with the mobile IAB status. Numerous other aspects are described.

### CROSS-REFERENCE TO RELATED APPLICATION

This patent application claims priority to U.S. Provisional Patent Application No. 63/484,910, filed on Feb. 14, 2023, entitled “MOBILITY FOR A MOBILE INTEGRATED ACCESS AND BACKHAUL CELL,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for mobility for a mobile integrated access and backhaul cell.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication that a cell is associated with a mobile integrated access and backhaul (IAB) status indicating that the cell is a mobile cell. The method may include performing a cell selection or reselection operation based at least in part on an onboard status between the UE and the cell and based at least in part on the cell being associated with the mobile IAB status, wherein the onboard status indicates that the UE is onboard a moving entity.

Some aspects described herein relate to a UE for wireless communication. The UE may include a memory and one or more processors coupled to the memory. The one or more processors may be configured to receive an indication that a cell is associated with a mobile IAB status indicating that the cell is a mobile cell. The one or more processors may be configured to perform a cell selection or reselection operation based at least in part on an onboard status between the UE and the cell and based at least in part on the cell being associated with the mobile IAB status, wherein the onboard status indicates that the UE is onboard a moving entity.

Some aspects described herein relate to a non-transitory computer-readable medium that stores a set of instructions for wireless communication by a UE. The set of instructions, when executed by one or more processors of the UE, may cause the UE to receive an indication that a cell is associated with a mobile IAB status indicating that the cell is a mobile cell. The set of instructions, when executed by one or more processors of the UE, may cause the UE to perform a cell selection or reselection operation based at least in part on an onboard status between the UE and the cell and based at least in part on the cell being associated with the mobile IAB status, wherein the onboard status indicates that the UE is onboard a moving entity.

Some aspects described herein relate to an apparatus for wireless communication. The apparatus may include means for receiving an indication that a cell is associated with a mobile IAB status indicating that the cell is a mobile cell. The apparatus may include means for performing a cell selection or reselection operation based at least in part on an onboard status between the apparatus and the cell and based at least in part on the cell being associated with the mobile IAB status, wherein the onboard status indicates that the UE is onboard a moving entity.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of radio access networks, in accordance with the present disclosure.

FIG. 5 is a diagram illustrating an example of an integrated access and backhaul (IAB) network architecture, in accordance with the present disclosure.

FIG. 6 illustrates an example of a wireless network in which a UE may support communication modes, in accordance with the present disclosure.

FIG. 7 is a diagram illustrating an example of signaling associated with determination of an onboard status and cell selection or reselection, in accordance with the present disclosure.

FIG. 8 is a diagram illustrating an example process performed, for example, by a UE, in accordance with the present disclosure.

FIG. 9 is a diagram of an example apparatus for wireless communication, in accordance with the present disclosure.

### DETAILED DESCRIPTION

A user equipment (UE) may access a wireless network via a cell provided by a network node, such as an integrated access and backhaul (IAB) node. In some deployments, a network node (and a cell provided by the network node) can be mobile, meaning that the network node can move with an entity to which the network node is affixed or associated. A UE may be onboard the entity to which the network node is affixed, meaning that the UE may move with the network node and the cell. This may be referred to as the UE having an onboard status with regard to the network node. In some examples, the UE may be in a radio resource control (RRC) idle mode or an RRC inactive mode, meaning that the UE performs cell selection and reselection operations such that the UE remains camped on a cell. Legacy cell selection and reselection operations may be suboptimal for a UE that is associated with an onboard status, since the UE may be likely to remain in coverage of a mobile IAB node and may be likely to detect many different cells as a result of cell selection measurements. However, the UE may not have information indicating that the UE is associated with the onboard status. Thus, the UE cannot perform cell selection and reselection operations that are suitable for UEs associated with an onboard status, which reduces efficiency of network resource usage and causes unnecessary cell selection or reselection operations.

Some techniques described herein provide cell selection and reselection operations based at least in part on an onboard status between a UE and a cell, and based at least in part on the cell being associated with a mobile IAB status (e.g., the cell being associated with a mobile IAB node). For example, a UE may receive an indication that the cell is associated with the mobile IAB status. The UE may perform a cell selection or reselection operation based at least in part on the cell being associated with the mobile IAB status and based at least in part on an onboard status between the UE and the cell. By performing the cell selection or reselection operation based at least in part on the mobile IAB status and the onboard status, efficiency of network resource usage is increased and occurrence of unnecessary cell selection or reselection operations is reduced.

Some techniques described herein provide a determination that a UE is associated with an onboard status with regard to a cell. For example, the UE may determine that the UE is associated with the onboard status based on detecting the cell for a first threshold length of time. As another example, the UE may determine that the UE is associated with the onboard status based on camping on the cell for a second threshold length of time. By determining, at the UE, that the UE is associated with an onboard status, processing load and complexity are reduced at the cell.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

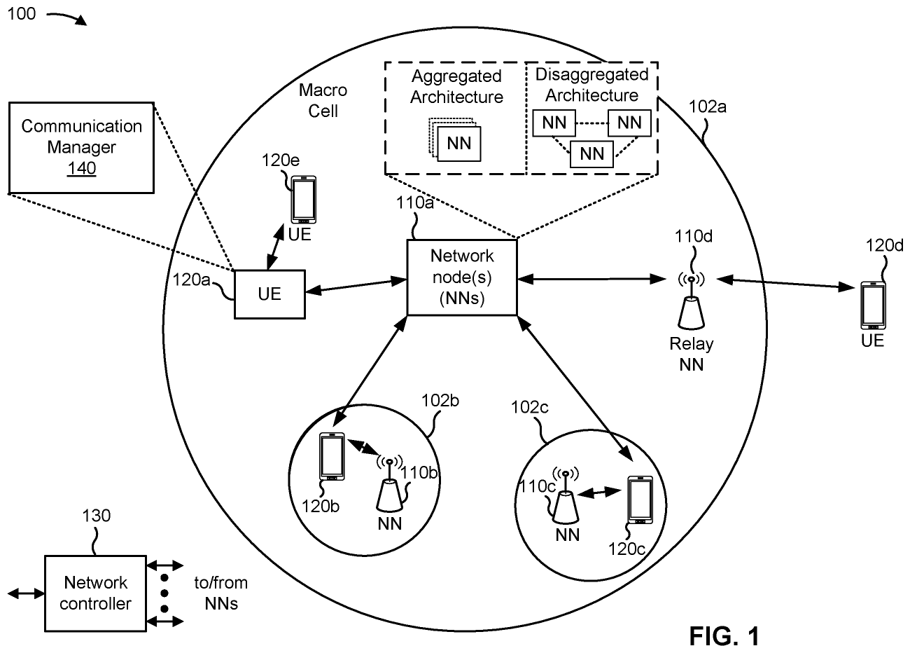

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication that a cell is associated with a mobile integrated access and backhaul (IAB) status; and perform a cell selection or reselection operation based at least in part on an onboard status between the UE and the cell and based at least in part on the cell being associated with the mobile IAB status. Additionally, or alternatively, the communication manager 140 may perform one or more other operations described herein.

As indicated above, FIG. 1 is provided as an example. Other examples may differ from what is described with regard to FIG. 1.

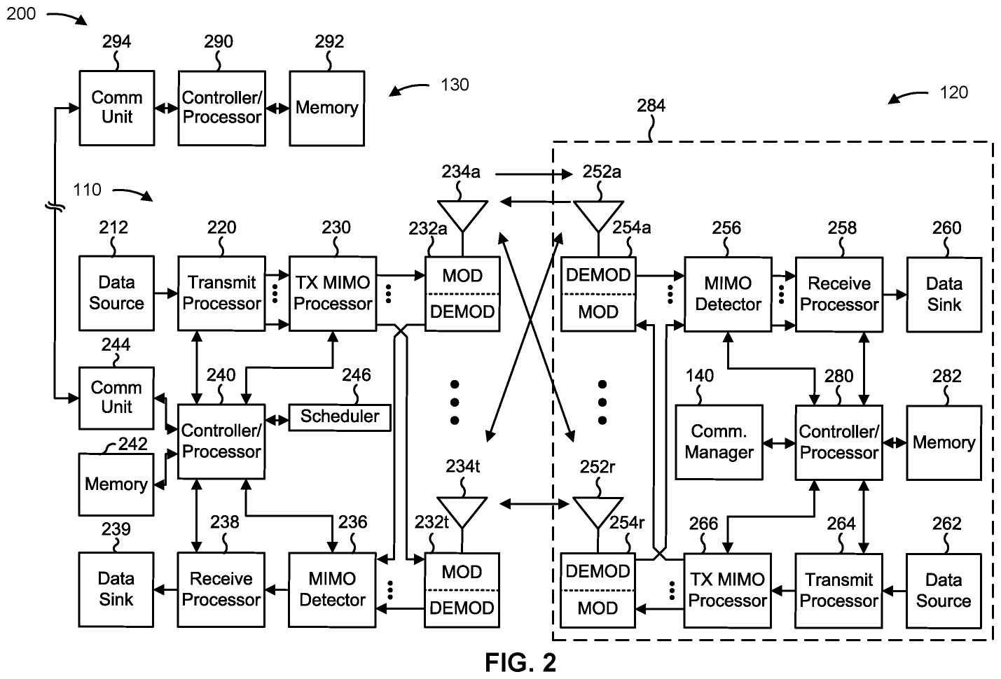

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

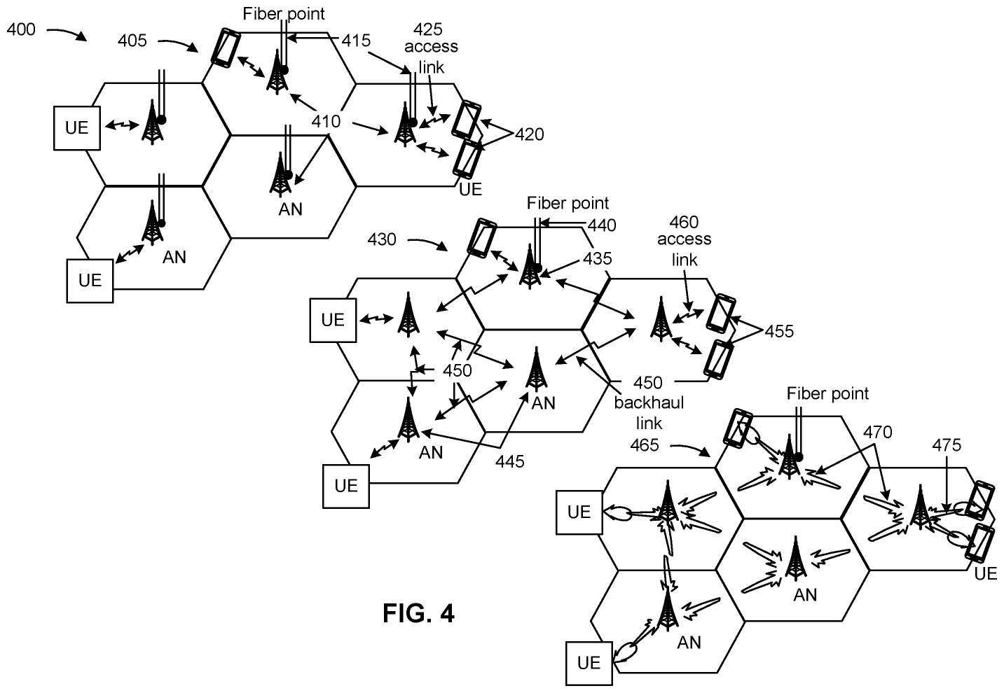

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

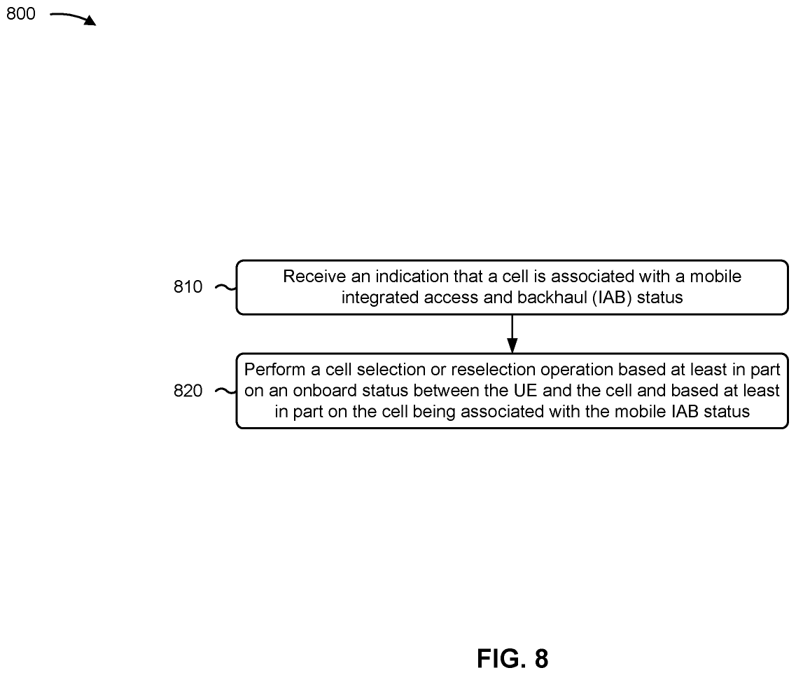

The controller/processor 240 of the network node 110, the controller/processor 280 of the UE 120, and/or any other component(s) of FIG. 2 may perform one or more techniques associated with cell selection and reselection, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving (e.g., using antenna 252, modem 254, MIMO detector 256, receive processor 258, controller/processor 280, and/or the like) an indication that a cell is associated with a mobile IAB status; and/or means for performing (e.g., using antenna 252, modem 254, MIMO detector 256, receive processor 258, controller/processor 280, and/or the like) a cell selection or reselection operation based at least in part on an onboard status between the UE and the cell and based at least in part on the cell being associated with the mobile IAB status. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

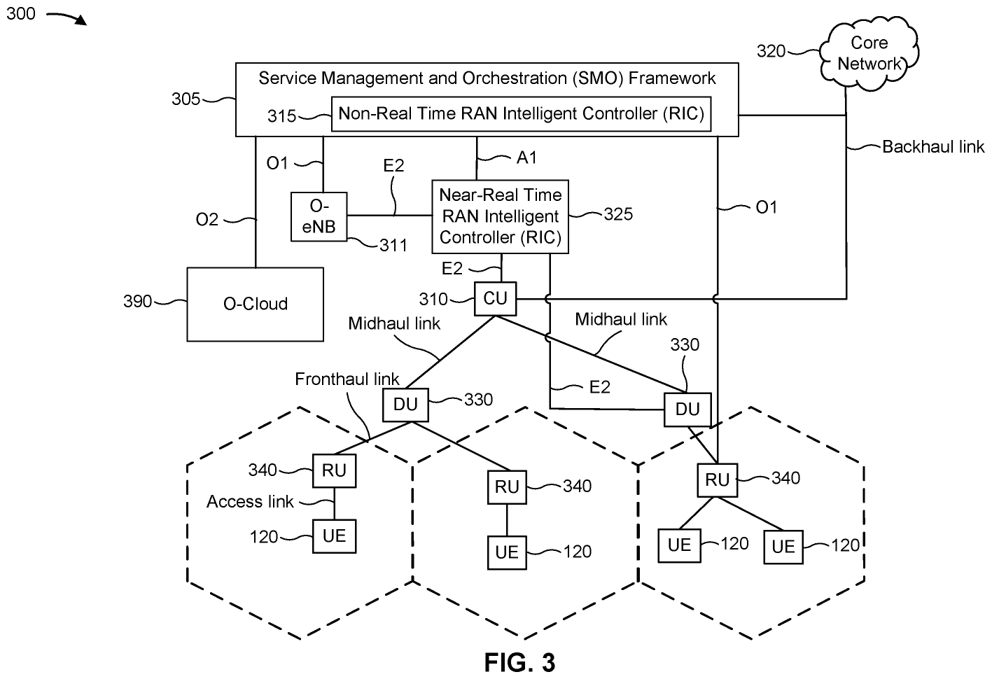

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400 of radio access networks, in accordance with the present disclosure.

As shown by reference number 405, a traditional (e.g., 3G, 4G, or LTE) radio access network may include multiple network nodes 410 (e.g., base stations) (illustrated as access nodes (AN)), where each network node 410 communicates with a core network via a wired backhaul link 415, such as a fiber connection. A network node 410 may communicate with a UE 420 via an access link 425, which may be a wireless link. In some aspects, a network node 410 shown in FIG. 4 may be a network node 110 shown in FIG. 1. In some aspects, a UE 420 shown in FIG. 4 may be a UE 120 shown in FIG. 1.

As shown by reference number 430, a radio access network may include a wireless backhaul network, sometimes referred to as an integrated access and backhaul (IAB) network. In an IAB network, at least one network node is an anchor network node 435 that communicates with a core network via a wired backhaul link 440, such as a fiber connection. An anchor network node 435 may also be referred to as an IAB donor (or IAB-donor). The IAB network may include one or more non-anchor network nodes 445, sometimes referred to as relay nodes, relay base stations or IAB nodes (or IAB-nodes). The non-anchor network node 445 may communicate directly or indirectly with the anchor network node 435 via one or more backhaul links 450 (e.g., via one or more non-anchor network nodes 445) to form a backhaul path to the core network for carrying backhaul traffic. Backhaul link 450 may be a wireless link. Anchor network node(s) 435 and/or non-anchor network node(s) 445 may communicate with one or more UEs 455 via access links 460, which may be wireless links for carrying access traffic. In some aspects, an anchor network node 435 and/or a non-anchor network node 445 shown in FIG. 4 may be a network node 110 shown in FIG. 1. In some aspects, a UE 455 shown in FIG. 4 may be a UE 120 shown in FIG. 1.

As shown by reference number 465, in some aspects, a radio access network that includes an IAB network may utilize millimeter wave technology and/or directional communications (e.g., beamforming) for communications between network nodes and/or UEs (e.g., between two network nodes, between two UEs, and/or between a network node and a UE). For example, wireless backhaul links 470 between network nodes may use millimeter wave signals to carry information and/or may be directed toward a target network node using beamforming. Similarly, the wireless access links 475 between a UE and a network node may use millimeter wave signals and/or may be directed toward a target wireless node (e.g., a UE and/or a network node). In this way, inter-link interference may be reduced.

The configuration of network nodes and UEs in FIG. 4 is shown as an example, and other examples are contemplated. For example, one or more base stations illustrated in FIG. 4 may be replaced by one or more UEs that communicate via a UE-to-UE access network (e.g., a peer-to-peer network or a device-to-device network). In this case, an anchor node may refer to a UE that is directly in communication with a network node (e.g., an anchor network node or a non-anchor network node).

As indicated above, FIG. 4 is provided as an example. Other examples may differ from what is described with regard to FIG. 4.

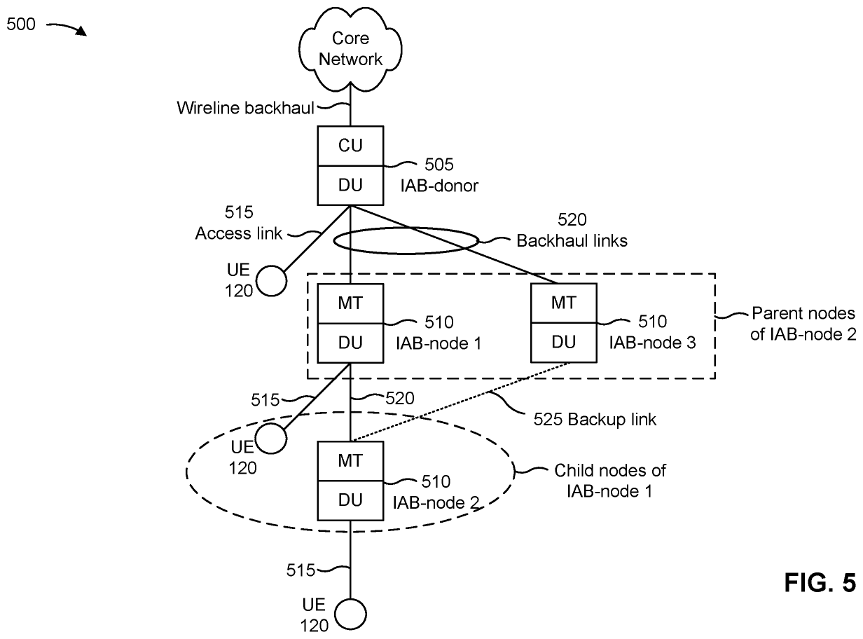

FIG. 5 is a diagram illustrating an example 500 of an IAB network architecture, in accordance with the present disclosure.

As shown in FIG. 5, an IAB network may include an IAB donor 505 (shown as IAB-donor) that connects to a core network via a wired connection (shown as a wireline backhaul). For example, an Ng interface of an IAB donor 505 may terminate at a core network. Additionally, or alternatively, an IAB donor 505 may connect to one or more devices of the core network that provide a core access and mobility management function (AMF). In some aspects, an IAB donor 505 may include a network node 110, such as an anchor network node, as described above in connection with 4. As shown, an IAB donor 505 may include a CU, which may perform access node controller (ANC) functions and/or AMF functions. The CU may configure a DU of the IAB donor 505 and/or may configure one or more IAB nodes 510 (e.g., a mobile terminal (MT) and/or a DU of an IAB node 510) that connect to the core network via the IAB donor 505. Thus, a CU of an IAB donor 505 may control and/or configure the entire IAB network that connects to the core network via the IAB donor 505, such as by using control messages and/or configuration messages (e.g., a radio resource control (RRC) configuration message or an F1 application protocol (F1-AP) message).

As further shown in FIG. 5, the IAB network may include IAB nodes 510 (shown as IAB-node 1, IAB-node 2, and IAB-node 3) that connect to the core network via the IAB donor 505. As shown, an IAB node 510 may include mobile termination (MT) functions (also sometimes referred to as UE functions (UEF)) and may include DU functions (also sometimes referred to as access node functions (ANF)). The MT functions of an IAB node 510 (e.g., a child node) may be controlled and/or scheduled by another IAB node 510 (e.g., a parent node of the child node) and/or by an IAB donor 505. The DU functions of an IAB node 510 (e.g., a parent node) may control and/or schedule other IAB nodes 510 (e.g., child nodes of the parent node) and/or UEs 120. Thus, a DU may be referred to as a scheduling node or a scheduling component, and an MT may be referred to as a scheduled node or a scheduled component. In some aspects, an IAB donor 505 may include DU functions and not MT functions. That is, an IAB donor 505 may configure, control, and/or schedule communications of IAB nodes 510 and/or UEs 120. A UE 120 may include only MT functions, and not DU functions. That is, communications of a UE 120 may be controlled and/or scheduled by an IAB donor 505 and/or an IAB node 510 (e.g., a parent node of the UE 120).

When a first node controls and/or schedules communications for a second node (e.g., when the first node provides DU functions for the second node's MT functions), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an IAB donor 505 or an IAB node 510, and a child node may be an IAB node 510 or a UE 120. Communications of an MT function of a child node may be controlled and/or scheduled by a parent node of the child node.

As further shown in FIG. 5, a link between a UE 120 (e.g., which only has MT functions, and not DU functions) and an IAB donor 505, or between a UE 120 and an IAB node 510, may be referred to as an access link 515. Access link 515 may be a wireless access link that provides a UE 120 with radio access to a core network via an IAB donor 505, and optionally via one or more IAB nodes 510. Thus, the network illustrated in 5 may be referred to as a multi-hop network or a wireless multi-hop network.

As further shown in FIG. 5, a link between an IAB donor 505 and an IAB node 510 or between two IAB nodes 510 may be referred to as a backhaul link 520. Backhaul link 520 may be a wireless backhaul link that provides an IAB node 510 with radio access to a core network via an IAB donor 505, and optionally via one or more other IAB nodes 510. In an IAB network, network resources for wireless communications (e.g., time resources, frequency resources, and/or spatial resources) may be shared between access links 515 and backhaul links 520. In some aspects, a backhaul link 520 may be a primary backhaul link or a secondary backhaul link (e.g., a backup backhaul link). In some aspects, a secondary backhaul link may be used if a primary backhaul link fails, becomes congested, and/or becomes overloaded, among other examples. For example, a backup link 525 between IAB-node 2 and IAB-node 3 may be used for backhaul communications if a primary backhaul link between IAB-node 2 and IAB-node 1 fails. As used herein, a node or a wireless node may refer to an IAB donor 505 or an IAB node 510.

In some aspects, a node may be a mobile IAB node. A mobile IAB node may include an IAB node (e.g., IAB donor 505 or IAB node 510) that is associated with (e.g., affixed to, in motion with) a moving entity, such as a vehicle (e.g., a bus, a train, a ship, an airship, a balloon, etc.). In some aspects, a mobile IAB node may not provide connectivity for downstream IAB nodes (e.g., only for UEs). A mobile IAB node may provide a cell via which UEs 120 may establish access links 515 with the mobile IAB node. In some situations, a UE 120 may move with a mobile IAB node (and thus the cell provided by the mobile IAB node), for example, because the UE 120 is located in or on the moving entity. In some other situations, a UE 120 may not move with a mobile IAB node, for example, because the UE 120 is not located in or on the moving entity. An IAB node may transmit an indication that the IAB node is a mobile IAB node. For example, the IAB node may transmit the indication via broadcast system information, RRC signaling, or the like. The UE 120 may perform various operations based at least in part on this indication, as described elsewhere herein.

As indicated above, FIG. 5 is provided as an example. Other examples may differ from what is described with regard to FIG. 5.

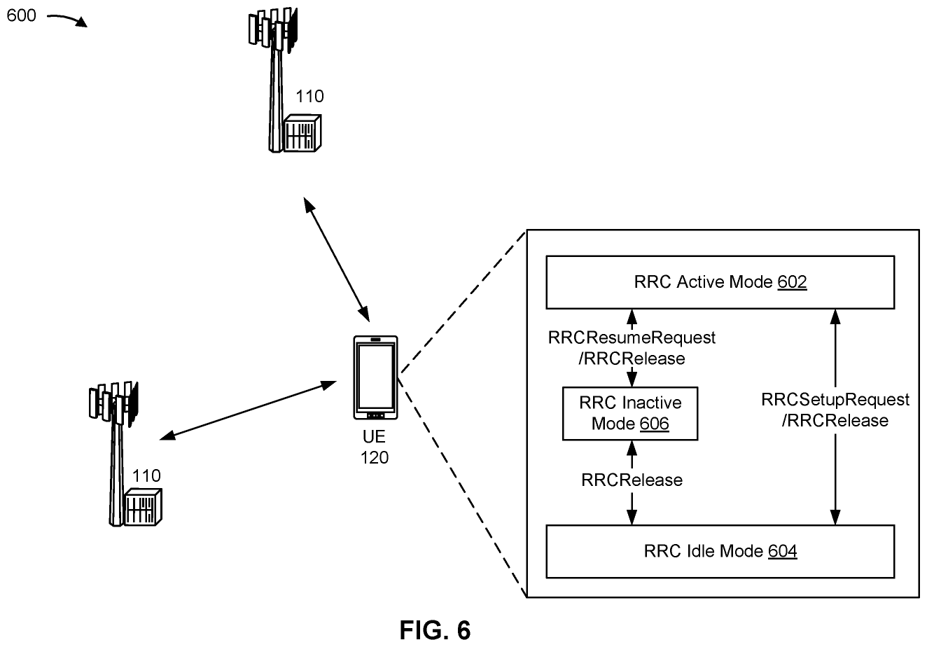

FIG. 6 illustrates an example 600 of a wireless network (e.g., wireless network 100) in which a UE (e.g., a UE 120) may support additional communication modes, in accordance with the present disclosure. The UE may be communicatively connected with one or more network nodes 110 in the wireless network. For example, the UE may be connected to the one or more network nodes 110 in a dual connectivity configuration. In this case, a first network node 110 may serve the UE as a master node and a second network node 110 may serve the UE as a secondary node.

As illustrated in FIG. 6, the UE may support a connected communication mode (e.g., an RRC active mode 602), an idle communication mode (e.g., an RRC idle mode 604), and an inactive communication mode (e.g., an RRC inactive mode 606). RRC inactive mode 606 may functionally reside between RRC active mode 602 and RRC idle mode 604.

The UE may transition between different modes based at least in part on various commands and/or communications received from the one or more network nodes 110. For example, the UE may transition from RRC active mode 602 or RRC inactive mode 606 to RRC idle mode 604 based at least in part on receiving an RRCRelease communication. As another example, the UE may transition from RRC active mode 602 to RRC inactive mode 606 based at least in part on receiving an RRCRelease with suspendConfig communication. As another example, the UE may transition from RRC idle mode 604 to RRC active mode 602 based at least in part on receiving an RRCSetupRequest communication. As another example, the UE may transition from RRC inactive mode 606 to RRC active mode 602 based at least in part on receiving an RRCResumeRequest communication.

When transitioning to RRC inactive mode 606, the UE and/or the one or more network nodes 110 may store a UE context (e.g., an access stratum (AS) context and/or higher-layer configurations). This permits the UE and/or the one or more network nodes 110 to apply the stored UE context when the UE transitions from RRC inactive mode 606 to RRC active mode 602 in order to resume communications with the one or more network nodes 110, which reduces latency of transitioning to RRC active mode 602 relative to transitioning to the RRC active mode 602 from RRC idle mode 604.

In some cases, the UE may communicatively connect with a new master node when transitioning from RRC idle mode 604 or RRC inactive mode 606 to RRC active mode 602 (e.g., a master node that is different from the last serving master node when the UE transitioned to RRC idle mode 604 or RRC inactive mode 606). In this case, the new master node may be responsible for identifying a secondary node for the UE in the dual connectivity configuration.

The UE may start in the RRC idle mode 604 when the UE initially camps on a cell. “Cell selection” is a mobility procedure for a UE to identify a cell on which to camp. Cell selection is applicable after a UE is powered on, after a UE leaves the RRC activated mode 602, and after the UE returns to an area of coverage. While camped on a cell, the UE may read system information, perform registration area updates with a core network, apply discontinuous reception (DRX) for paging, and monitor a physical downlink control channel (PDCCH) for downlink control information (DCI) or core network paging. The UE may switch from camping on one cell to camping on another cell by performing cell reselection. Cell reselection is a mobility procedure for UEs in the RRC idle mode 604 or the RRC inactive mode 606. Cell selection may include: scanning radio frequency channels within supported frequency bands of the UE according to a synchronization raster; searching for one or more synchronization signal blocks at each carrier frequency; identifying a strongest cell based on searching for the one or more synchronization signal blocks; and camping on the strongest cell if the strongest cell is a “suitable cell” or an “acceptable cell.” Cell reselection may include: performing measurements on a set of cells, ranking the set of cells based at least in part on the measurements, and camping on a cell selected from the ranked set of cells. Cell selection and reselection may be performed according to various rules and criteria, such as an Srxlev criterion, an Squal criterion, a Qrlxevmin criterion, a Qqualmin criterion, a prioritization rule (indicating that particular cells or particular types of cells should be prioritized or deprioritized for selection or reselection), a reselection timer (e.g., which may correspond to a mobility state of the UE), a time interval for measurement, or the like.

As indicated above, FIG. 6 is provided as an example. Other examples may differ from what is described with regard to FIG. 6.

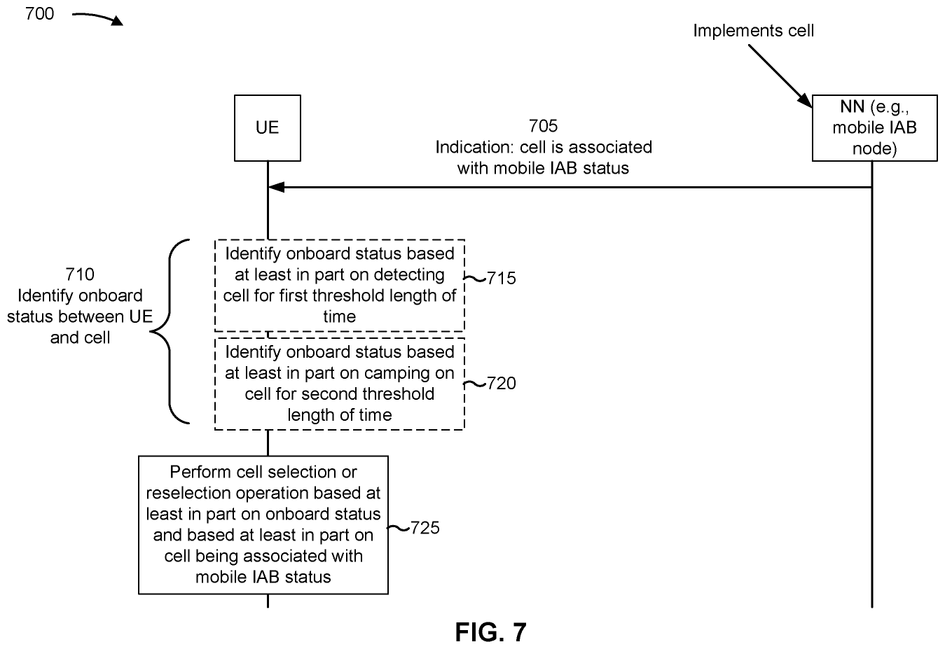

FIG. 7 is a diagram illustrating an example 700 of signaling associated with determination of an onboard status and cell selection or reselection, in accordance with the present disclosure. Example 700 includes a UE (e.g., UE 120) and a network node (e.g., network node 110, IAB donor 505, IAB node 510). The network node may be a mobile IAB node, as described above. The network node may implement a cell. It should be understood that references to communications between the UE and the network node also include the same communications between the UE and the cell implemented by the network node, and vice versa. Operations described herein as being performed by the cell may be performed by the network node implementing the cell.

As shown by reference number 705, the network node may output, and the UE may receive, an indication that the cell is associated with a mobile IAB status. For example, the indication may indicate that the network node is a mobile IAB node. The network node may output the indication via any suitable form of signaling, such as broadcast system information (e.g., system information block 1 (SIB1), RRC signaling, or the like). In some aspects, the indication may indicate one or more cells that are associated with the mobile IAB status. In some aspects, the indication may indicate a cell, other than a cell implemented by the network node that outputs the indication, that is associated with a mobile IAB status. For example, the indication may identify a list of candidate cells with mobile IAB statuses. For example, the UE may receive assistance information indicating one or more cells or frequencies that may have a mobile IAB status (e.g., may belong to a mobile cell). This information can be provided in system information (SI) broadcast by the cell on which the UE camps (e.g., SIB2, SIB3, SIB4, or another SIB), in a dedicated RRC message (such as an RRC release message) when the UE is connected to the network, via a reconfiguration message, or in an operations, administration, and maintenance (OAM) configuration. Providing the list of cells with mobile IAB statuses may reduce power consumption by the UE in connection with acquiring SIBs of each neighbor cell to determine whether each neighbor cell transmits an indication of a mobile IAB status. In some aspects, the UE may attempt to read system information from one or more cells (e.g., neighboring cells) to determine whether the one or more cells are associated with a mobile IAB status. For example, the UE may read the system information prior to performing initial access with the one or more cells. The UE may use this system information to identify an onboard status with the one or more cells, as described below.

As shown by reference number 710, the UE may identify an onboard status between the UE and the cell (e.g., the network node). The identification of the onboard status can occur before selecting the cell for camping (e.g., during measurement of the cell), immediately before selecting the cell for camping, or after selecting the cell for camping. In some aspects, the onboard status between the UE and the cell may indicate that the UE is onboard a moving entity to which the network node is affixed or associated. In some aspects, the onboard status between the UE and the cell may indicate that the UE is expected to remain in a coverage area of the cell for a threshold length of time.

As shown by reference number 715, in some aspects, the UE may identify the onboard status based on detecting the cell for a first threshold length of time. For example, the UE may detect the cell for a first threshold length of time, and may identify the onboard status in response to detecting the cell for the first threshold length of time. The first threshold length of time may be configured (e.g., the network node may output, and the UE may receive, configuration information indicating the first threshold length of time). In some aspects, the onboard status is based at least in part on detecting the cell for the first threshold length of time while the UE is camped on another cell not associated with the mobile IAB status. For example, the other cell may be a stationary cell (e.g., a cell not implemented by a mobile IAB node). Thus, the UE may identify an onboard status, while camped on a stationary cell, based at least in part on observing a mobile IAB cell for a second threshold length of time. The UE may be in a normal-mobility state, a medium-mobility state, or a high-mobility state (as defined, for example, in 3GPP Technical Specification 38.304) during the identification of the onboard status. Mobility states may correspond to how frequently the UE has reselected a new cell (on which to camp) within a configured time interval. In some aspects, the determination of the onboard status based on detecting the cell for the first threshold length of time may be applicable to all mobility states (including a normal-mobility state, a medium-mobility state, or a high-mobility state). In some other aspects, the determination of the onboard status based on detecting the cell for the first threshold length of time may be applicable to a proper subset of the mobility states (e.g., one or more of the normal-mobility state, the medium-mobility state, or the high-mobility state). For example, the UE may determine the onboard status based on detecting the cell for the first threshold length of time only if the UE is in a medium-mobility state or a high-mobility state. Additionally, or alternatively, a parameter used to determine the onboard status (such as a length of the first threshold length of time, a measurement threshold, a measurement offset, or the like) may be derived from a current mobility state of the UE.

As mentioned, the UE may identify the onboard status based at least in part on detecting the cell for the first threshold length of time. “Detecting the cell” may include detecting a signal transmitted by the cell. In some aspects, “detecting the cell” may include performing a measurement. For example, the UE may detect the cell when the UE detects a signal transmitted by the cell, and when a measurement on the signal (e.g., an RSRP measurement, an RSRQ measurement, an Srxlev measurement, an Squal measurement, or a combination thereof) satisfies a measurement threshold. Additionally, or alternatively, the UE may detect the cell when a variation in a measurement on the signal is lower than a threshold.

As shown by reference number 720, in some aspects, the UE may identify the onboard status (or may maintain an onboard status) for a cell based at least in part on camping on the cell for a second threshold length of time. In some aspects, the second threshold length of time may be different than the first threshold length of time. For example, the second threshold length of time (e.g., the time duration to declare or maintain an onboard status if already camped on a cell) may be shorter than the first threshold length of time (e.g., the time duration to identify a cell as having an onboard status when the UE initially camps on a stationary cell). A length of the second threshold length of time may be configured (e.g., the UE may receive configuration information indicating the length of the second threshold length of time). In some aspects, the length of the second threshold length of time may be based at least in part on a mobility state of the UE. For example, the length of the second threshold length of time may be different in a first mobility state (e.g., a high-mobility state) than in a second mobility state (e.g., a normal-mobility state).

As shown by reference number 725, the UE may perform a cell selection or reselection operation based at least in part on the onboard status and based at least in part on the cell being associated with the mobile IAB status. Details regarding the cell selection operation and the cell reselection operation are provided below.

In some aspects, the UE may prioritize selecting or reselecting cells associated with the mobile IAB status over stationary cells. For example, the UE may perform this prioritization by assigning a higher (or highest) absolute priority to cells or frequencies associated with the mobile IAB status. In this example, a rule may be defined indicating to assign a highest priority to cells associated with a mobile IAB status (or to associated frequencies), or appropriate parameters may be configured (e.g., offsets, or scaling factors, or absolute values) for application to cells associated with mobile IAB status (or associated frequencies). In some aspects, the higher absolute priority may be configurable (e.g., the UE may assign a configured absolute priority to a given cell or frequency that is associated with the mobile IAB status). As another example, when ranking cells for cell reselection (e.g., based at least in part on RSRP measurements of the cells), cells associated with a mobile IAB status may be assigned a higher (e.g., configurable) or highest rank relative to stationary cells. In this example, a rule can be defined indicating to assign a highest rank to cells associated with a mobile IAB status (or to associated frequencies), or appropriate parameters may be configured (e.g., offsets, or scaling factors, or absolute values) for ranking of cells associated with mobile IAB status (or associated frequencies). As yet another example, the UE may select a cell having a mobile IAB status for which a value (e.g., an R value, which may be derived from an RSRP measurement quantity Qₘₑₐₛ, a Qoffset value, and/or a Qoffsetₜₑₘₚ value) is within a range (e.g., a range indicated by a rangeToBestCell parameter or a parameter similar to rangeToBestCell) of a cell having a best value.

In some aspects, the UE may determine a mobility state (as described above) based at least in part on the onboard status. For example, upon identifying an onboard status, the UE may assume a changed mobility state. For example, the UE may be camped on a stationary cell, and may determine a medium-mobility state or a high-mobility state. Upon entering the onboard status, the UE may determine a normal-mobility state (e.g., on the expectation that the UE will be camping for a relatively longer period of time on the same cell since the UE has an onboard status with regard to the cell). This may have an impact on reselection timers or hysteresis values of the cell selection operation or the cell reselection operation, as described elsewhere herein. For example, the UE may modify the reselection timer or hysteresis value. In some aspects, a parameter used to determine the mobility state may be based at least in part on the onboard status. For example, a parameter used to determine the mobility state (such as a time duration or a number of reselections) may be adjusted or selected in accordance with the mobility state (e.g., different values of the parameters may be used for different mobility states). As another example, a rule may be defined such that a reselection between cells associated with onboard statuses does not count toward a parameter used to determine the mobility state. For example, the UE may not consider consecutive reselections of mobile IAB cells for mobility state detection criteria. This may avoid unnecessary elevation of the mobility state when a mobile IAB cell's cell identifier changes, for example, due to the mobile IAB cell's DU switching from one CU to another CU.

In some aspects, as mentioned above, the UE may reselect from a first cell associated with a mobile IAB node to a second cell associated with a mobile IAB node. For example, the UE may have the onboard status with regard to the first cell. This may occur, for example, because a DU of the mobile IAB node may migrate from a first CU to a second CU (leading to a change in a cell identifier from the first cell to the second cell), or because of a cell identifier collision causing a change in a cell identifier from the first cell to the second cell. In this example, the UE may maintain the onboard status when reselecting from a first cell associated with a mobile IAB node to a second cell associated with a mobile IAB node. Additionally, or alternatively, the UE may reset a timer associated with the onboard status (e.g., the second threshold length of time), and may identify whether the UE is associated with an onboard status with regard to the second cell. For example, the UE may reset its timer and attempt to determine whether the UE has the onboard status with respect to a newly selected mobile IAB cell.

In some aspects, the UE may relax measurements, or refrain from relaxing measurements, based at least in part on the onboard status. Typically, a UE can relax measurements (referred to herein as using a baseline measurement configuration) when in a low-mobility state (which is different than the normal-mobility, medium-mobility, and high-mobility states mentioned above), which may be defined as observing less than a threshold variation in a measurement on a serving cell for a length of time, or when the UE is not near a cell edge, which may be defined as observing a measurement (e.g., RSRP or RSRQ) of a serving cell being above a threshold for a length of time. These conditions may be satisfied after camping on a cell with an onboard status, leading to a relaxed measurement schedule (e.g., a decreased frequency of cell measurements for reselection operations). The configuration for performing relaxed measurements may be indicated by system information (e.g., SIB2). However, a cell identifier of the cell may change (e.g., as a result of a migration of an IAB DU from one CU to another CU). If the cell identifier changes frequently, then a timer parameter for cell reselection (e.g., T_{SearchDeltaP}) may reset frequently, leading to a lack of relaxation of measurements, which may be desirable when the cell identifier changes frequently. Conversely, if the cell identifier does not change frequently, the UE may relax measurements, which may conserve power. However, there are situations in which the cell identifier changes frequently enough that a non-relaxed measurement schedule may be beneficial, but not so frequently that the UE avoids the low-mobility state. Therefore, the UE may relax measurements when the UE would actually benefit from performing more frequent measurements due to the changing cell identifier. In some aspects, the UE may not relax measurements while camped on a cell having an onboard status, which ensures that the UE can measure the cell in the event of a changed cell identifier. In some other aspects, the UE may perform cell measurements according to a measurement configuration corresponding to the onboard status. For example, upon identifying the onboard condition, the UE may apply parameters for declaring the low-mobility state or the “near a cell edge” state (e.g., detection parameters, measurement parameters, and/or evaluation parameters) that correspond to the onboard status. As another example, the UE may apply a scaling factor to a configuration for relaxed measurements, such as to reduce a duration of the relaxed measurements or to shorten the periodicity of measurements in the relaxed measurement state. As yet another example, a configuration (e.g., a relaxedMeasurement parameter in SIB2) may indicate a configuration for relaxed measurement that is specific for cells associated with the mobile IAB status (e.g., mobile IAB cells), or may indicate a configuration for relaxed measurement in a cell-specific manner (for a particular cell) or a frequency-specific manner (for a particular frequency). In some aspects, the UE may receive signaling (e.g., configuration information) indicating whether the UE should perform measurement relaxation according to a typical procedure (as defined above) or based at least in part on the onboard status.

In some aspects, the UE may not be associated with an onboard status with regard to a cell. For example, the UE may determine that a condition of the onboard status is not satisfied (as described above). In this example, the UE may use a legacy procedure for cell selection or cell reselection (e.g., a procedure that is not based on the onboard status). Alternatively, the UE may deprioritize selection or reselection to a cell associated with a mobile IAB status, which reduces the likelihood of the UE performing frequent cell reselection due to camping on a mobile IAB cell that is likely to move away from the UE.

The signaling illustrated with regard to FIG. 7 can be performed using any combination of system information (e.g., SIB1 or remaining minimum system information) transmitted by the cell having the onboard status, system information (e.g., SIB2, SIB3, SIB4, or another SIB) broadcasted by another cell (e.g., a stationary cell, a neighbor cell), or a dedicated RRC message (e.g., an RRC release message) provided by a serving cell of the UE. In some aspects, any one or more parameters or values described with regard to FIG. 7 may be defined by a preconfiguration or by a wireless communication specification.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with mobility for a mobile IAB cell.

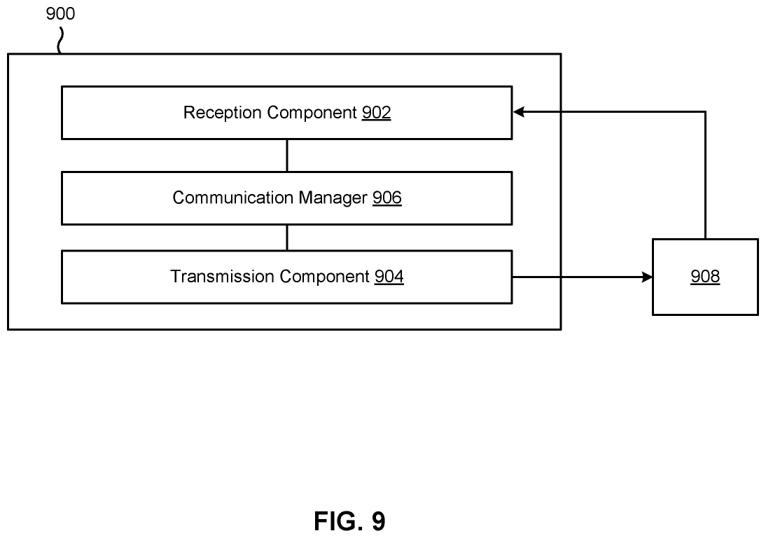

As shown in FIG. 8, in some aspects, process 800 may include receiving an indication that a cell is associated with a mobile IAB status (block 810). For example, the UE (e.g., using reception component 902 and/or communication manager 906, depicted in FIG. 9) may receive an indication that a cell is associated with a mobile IAB status, as described above. The mobile IAB status may indicate that the cell is a mobile cell.

As further shown in FIG. 8, in some aspects, process 800 may include performing a cell selection or reselection operation based at least in part on an onboard status between the UE and the cell and based at least in part on the cell being associated with the mobile IAB status (block 820). For example, the UE (e.g., using communication manager 906, depicted in FIG. 9) may perform a cell selection or reselection operation based at least in part on an onboard status between the UE and the cell and based at least in part on the cell being associated with the mobile IAB status, as described above. The onboard status may indicate that the UE is onboard a moving entity.

Process 800 may include additional aspects, such as any single aspect or any combination of aspects described below and/or in connection with one or more other processes described elsewhere herein.

In a first aspect, process 800 includes detecting the cell for a first threshold length of time, wherein the onboard status is based at least in part on detecting the cell for the first threshold length of time.

In a second aspect, alone or in combination with the first aspect, the onboard status is based at least in part on detecting the cell for the first threshold length of time while the UE is camped on another cell not associated with the mobile IAB status.

In a third aspect, alone or in combination with one or more of the first and second aspects, process 800 includes receiving configuration information indicating the first threshold length of time.

In a fourth aspect, alone or in combination with one or more of the first through third aspects, performing the cell selection or reselection operation further comprises selecting the cell for camping based at least in part on the onboard status.

In a fifth aspect, alone or in combination with one or more of the first through fourth aspects, process 800 includes receiving information indicating a set of candidate cells, including the cell, that are potentially associated with the mobile IAB status.

In a sixth aspect, alone or in combination with one or more of the first through fifth aspects, process 800 includes camping on the cell for a second threshold length of time, wherein the onboard status is based at least in part on camping on the cell for the second threshold length of time.

In a seventh aspect, alone or in combination with one or more of the first through sixth aspects, the cell is a first cell, and performing the cell selection or reselection operation based at least in part on the onboard status further comprises reselecting a second cell associated with the mobile IAB status, and maintaining the onboard status with regard to the second cell.

In an eighth aspect, alone or in combination with one or more of the first through seventh aspects, the cell is a first cell, and performing the cell selection or reselection operation based at least in part on the onboard status further comprises reselecting a second cell associated with the mobile IAB status, and resetting a timer associated with the second threshold length of time.

In a ninth aspect, alone or in combination with one or more of the first through eighth aspects, performing the cell selection or reselection operation based at least in part on the onboard status further comprises prioritizing selection or reselection of cells associated with the mobile IAB status.

In a tenth aspect, alone or in combination with one or more of the first through ninth aspects, performing the cell selection or reselection operation based at least in part on the onboard status further comprises modifying a reselection timer or a hysteresis timer based at least in part on entering the onboard status.

In an eleventh aspect, alone or in combination with one or more of the first through tenth aspects, modifying the reselection timer is based at least in part on a mobility state parameter of the UE.

In a twelfth aspect, alone or in combination with one or more of the first through eleventh aspects, performing the cell selection or reselection operation based at least in part on the onboard status further comprises modifying a parameter used to determine a mobility state parameter of the UE based at least in part on the onboard status.

In a thirteenth aspect, alone or in combination with one or more of the first through twelfth aspects, performing the cell selection or reselection operation is based at least in part on a mobility state parameter, and reselection between cells associated with the mobile IAB status does not count toward a parameter used to determine the mobility state parameter.

In a fourteenth aspect, alone or in combination with one or more of the first through thirteenth aspects, performing the cell selection or reselection operation based at least in part on the onboard status further comprises performing cell measurements according to a baseline measurement configuration based at least in part on the onboard status.

In a fifteenth aspect, alone or in combination with one or more of the first through fourteenth aspects, performing the cell selection or reselection operation based at least in part on the onboard status further comprises performing cell measurements according to a measurement configuration corresponding to the onboard status.

In a sixteenth aspect, alone or in combination with one or more of the first through fifteenth aspects, process 800 includes receiving information indicating to use the measurement configuration corresponding to the onboard status.

In a seventeenth aspect, alone or in combination with one or more of the first through sixteenth aspects, the measurement configuration is specific to at least one of: cells associated with the mobile IAB status, a particular cell, or a particular frequency.

In an eighteenth aspect, alone or in combination with one or more of the first through seventeenth aspects, performing the cell selection or reselection operation based at least in part on the onboard status further comprises reselecting another cell not associated with the onboard status.

In a nineteenth aspect, alone or in combination with one or more of the first through eighteenth aspects, process 800 includes performing another cell selection or reselection operation deprioritizing cells associated with the mobile IAB status.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, an IAB node, or a base station), using the reception component 902 and the transmission component 904.

In some aspects, the apparatus 900 may be configured to perform one or more operations described herein in connection with FIGS. 4-7. Additionally, or alternatively, the apparatus 900 may be configured to perform one or more processes described herein, such as process 800 of FIG. 8, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive an indication that a cell is associated with a mobile IAB status. The communication manager 906 may perform a cell selection or reselection operation based at least in part on an onboard status between the UE and the cell and based at least in part on the cell being associated with the mobile IAB status.

The communication manager 906 may detect the cell for a first threshold length of time, wherein the onboard status is based at least in part on detecting the cell for the first threshold length of time.

The reception component 902 may receive configuration information indicating the first threshold length of time.

The reception component 902 may receive information indicating a set of candidate cells, including the cell, that are potentially associated with the mobile IAB status.

The communication manager 906 may camp on the cell for a second threshold length of time, wherein the onboard status is based at least in part on camping on the cell for the second threshold length of time.

The reception component 902 may receive information indicating to use the measurement configuration corresponding to the onboard status.

The communication manager 906 may perform another cell selection or reselection operation deprioritizing cells associated with the mobile IAB status.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving an indication that a cell is associated with a mobile integrated access and backhaul (IAB) status indicating that the cell is a mobile cell; and performing a cell selection or reselection operation based at least in part on an onboard status between the UE and the cell and based at least in part on the cell being associated with the mobile IAB status, wherein the onboard status indicates that the UE is onboard a moving entity.

Aspect 2: The method of Aspect 1, further comprising: detecting the cell for a first threshold length of time, wherein the onboard status is based at least in part on detecting the cell for the first threshold length of time.

Aspect 3: The method of Aspect 2, wherein the onboard status is based at least in part on detecting the cell for the first threshold length of time while the UE is camped on another cell not associated with the mobile IAB status.

Aspect 4: The method of Aspect 2, further comprising receiving configuration information indicating the first threshold length of time.

Aspect 5: The method of any of Aspects 1-4, wherein performing the cell selection or reselection operation further comprises selecting the cell for camping based at least in part on the onboard status.

Aspect 6: The method of any of Aspects 1-5, further comprising receiving information indicating a set of candidate cells, including the cell, that are potentially associated with the mobile IAB status.

Aspect 7: The method of any of Aspects 1-6, further comprising: camping on the cell for a second threshold length of time, wherein the onboard status is based at least in part on camping on the cell for the second threshold length of time.

Aspect 8: The method of Aspect 7, wherein the cell is a first cell, and wherein performing the cell selection or reselection operation based at least in part on the onboard status further comprises reselecting a second cell associated with the mobile IAB status; and maintaining the onboard status with regard to the second cell.

Aspect 9: The method of Aspect 7, wherein the cell is a first cell, and wherein performing the cell selection or reselection operation based at least in part on the onboard status further comprises reselecting a second cell associated with the mobile IAB status; and resetting a timer associated with the second threshold length of time.

Aspect 10: The method of any of Aspects 1-9, wherein performing the cell selection or reselection operation based at least in part on the onboard status further comprises prioritizing selection or reselection of cells associated with the mobile IAB status.

Aspect 11: The method of any of Aspects 1-10, wherein performing the cell selection or reselection operation based at least in part on the onboard status further comprises modifying a reselection timer or a hysteresis timer based at least in part on entering the onboard status.

Aspect 12: The method of Aspect 11, wherein modifying the reselection timer is based at least in part on a mobility state parameter of the UE.

Aspect 13: The method of any of Aspects 1-12, wherein performing the cell selection or reselection operation based at least in part on the onboard status further comprises modifying a parameter used to determine a mobility state parameter of the UE based at least in part on the onboard status.

Aspect 14: The method of any of Aspects 1-13, wherein performing the cell selection or reselection operation is based at least in part on a mobility state parameter, and wherein reselection between cells associated with the mobile IAB status does not count toward a parameter used to determine the mobility state parameter.

Aspect 15: The method of any of Aspects 1-14, wherein performing the cell selection or reselection operation based at least in part on the onboard status further comprises performing cell measurements according to a baseline measurement configuration based at least in part on the onboard status.

Aspect 16: The method of any of Aspects 1-15, wherein performing the cell selection or reselection operation based at least in part on the onboard status further comprises performing cell measurements according to a measurement configuration corresponding to the onboard status.

Aspect 17: The method of Aspect 16, further comprising receiving information indicating to use the measurement configuration corresponding to the onboard status.

Aspect 18: The method of Aspect 16, wherein the measurement configuration is specific to at least one of: cells associated with the mobile IAB status, a particular cell, or a particular frequency.

Aspect 19: The method of any of Aspects 1-18, wherein performing the cell selection or reselection operation based at least in part on the onboard status further comprises reselecting another cell not associated with the onboard status.

Aspect 20: The method of Aspect 19, further comprising performing another cell selection or reselection operation deprioritizing cells associated with the mobile IAB status.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive an indication that a cell is associated with a mobile integrated access and backhaul (IAB) status indicating that the cell is a mobile cell; and
perform a cell selection or reselection operation based at least in part on an onboard status of the UE and based at least in part on the cell being associated with the mobile IAB status, wherein the onboard status indicates that the UE is onboard a moving entity.

2. The UE of claim 1, wherein the one or more processors, to perform the cell selection or reselection operation, are configured to select the cell for camping based at least in part on the onboard status.

3. The UE of claim 1, wherein the one or more processors, to receive the indication, are configured to receive information indicating a set of candidate cells that are associated with the mobile IAB status.

4. The UE of claim 3, wherein the information indicating the set of candidate cells is in a system information block 4 (SIB4).

5. The UE of claim 1, wherein the one or more processors, to receive the indication, are configured to receive the indication in a system information block 1 (SIB1).

6. The UE of claim 1, wherein the one or more processors, to perform the cell selection or reselection operation based at least in part on the onboard status, are configured to prioritize selection or reselection of a cell associated with the mobile IAB status.

7. The UE of claim 6, wherein the one or more processors, to prioritize the selection or reselection, are configured to assign a highest priority to the cell associated with the mobile IAB status.

8. The UE of claim 1, wherein the one or more processors are further configured to:
camp on the cell for a second threshold length of time, wherein the onboard status is based at least in part on camping on the cell for the second threshold length of time.

9. The UE of claim 8, wherein the cell is a first cell, and wherein the one or more processors, to perform the cell selection or reselection operation based at least in part on the onboard status, are configured to:
reselect a second cell associated with the mobile IAB status; and
maintain the onboard status with regard to the second cell.

10. The UE of claim 8, wherein the cell is a first cell, and wherein the one or more processors, to perform the cell selection or reselection operation based at least in part on the onboard status, are configured to:
reselect a second cell associated with the mobile IAB status; and
reset a timer associated with the second threshold length of time.

11. The UE of claim 1, wherein the one or more processors, to perform the cell selection or reselection operation based at least in part on the onboard status, are configured to modify a parameter used to determine a mobility state parameter of the UE based at least in part on the onboard status.

12. The UE of claim 1, wherein the cell selection or reselection operation is based at least in part on a mobility state parameter, and wherein reselection between cells associated with the mobile IAB status does not count toward a parameter used to determine the mobility state parameter.

13. The UE of claim 1, wherein the one or more processors, to perform the cell selection or reselection operation based at least in part on the onboard status, are configured to perform cell measurements according to a baseline measurement configuration based at least in part on the onboard status.

14. The UE of claim 1, wherein the one or more processors, to perform the cell selection or reselection operation based at least in part on the onboard status, are configured to perform cell measurements according to a measurement configuration corresponding to the onboard status.

15. The UE of claim 1, wherein the one or more processors, to perform the cell selection or reselection operation based at least in part on the onboard status, are configured to reselect another cell not associated with the onboard status.

16. The UE of claim 1, wherein the one or more processors are further configured to:
detect the cell for a first threshold length of time, wherein the onboard status is based at least in part on detecting the cell for the first threshold length of time.

17. A method of wireless communication performed by a user equipment (UE), comprising:
receiving an indication that a cell is associated with a mobile integrated access and backhaul (IAB) status indicating that the cell is a mobile cell; and
performing a cell selection or reselection operation based at least in part on an onboard status between the UE and the cell and based at least in part on the cell being associated with the mobile IAB status, wherein the onboard status indicates that the UE is onboard a moving entity.

18. The method of claim 17, further comprising:
detecting the cell for a first threshold length of time, wherein the onboard status is based at least in part on detecting the cell for the first threshold length of time.

19. The method of claim 18, wherein the onboard status is based at least in part on detecting the cell for the first threshold length of time while the UE is camped on another cell not associated with the mobile IAB status.

20. A non-transitory computer-readable medium storing a set of instructions for wireless communication, the set of instructions comprising:
one or more instructions that, when executed by one or more processors of a user equipment (UE), cause the UE to:
receive an indication that a cell is associated with a mobile integrated access and backhaul (IAB) status indicating that the cell is a mobile cell; and
perform a cell selection or reselection operation based at least in part on an onboard status between the UE and the cell and based at least in part on the cell being associated with the mobile IAB status, wherein the onboard status indicates that the UE is onboard a moving entity.
